(19) United States
(12) Patent Application Publication
(10) Pub. No.: US 2011/0262113 A1
(43) Pub. Date: Oct. 27, 2011

(54) MULTI-FUNCTION ROASTER SYSTEM

(76) Inventor: WILLIAM HOME, Neihu (TW)

(21) Appl. No.: 12/766,915

(22) Filed: Apr. 25, 2010

(51) Int. Cl. F24C 1/00; A21B 2/00; A47J 27/00

(52) U.S. Cl. 392/307; 99/446; 392/416

(57) ABSTRACT

A multi-function roaster system includes a roasting oven serving as a main body formed by two oven sidewalls to which a liftable cover is rotatably mounted. A open top grating roasting assembly is arranged at a bottom of the roasting oven. At a suitable location adjacent to an inner top of the liftable cover, an infrared heating roasting assembly is frame-supported on an oven back wall. The top fired infrared heating roasting assembly includes a reflection plate that is inclined downward in a rearward direction and is arranged at a bottom of the infrared heating roasting assembly to guide greasing dropping induced by infrared heating roasting away from an open top roasting site on a lower portion and to reflect infrared radiation to heat a bottom side of a heating grating. As such a single system allows for selection among multiple roasting modes, includes open top grating roasting and top fired infrared heating roasting.

### (a) TECHNICAL FIELD OF THE INVENTION

The present invention generally relates to a multi-function roaster system, which allows for options for two modes of roasting, including open top grating roasting (radiant heat and hot air from the bottom of grate) and top-fired infrared heating roasting that are carried out in allocation vertically in the single system so that the drawback of conventional roasting equipments that are operated in a single or two roasting modes can be eliminated to facilitate the performance of various roasting skills by a roasting operator.

### (b) DESCRIPTION OF THE PRIOR ART

Roasting is a very popular way of cooking and dinning for it can be performed at any sites to provide quick foods to users in an outdoor location. In the old ages, no electricity was available and food cooking could only be done by burning coals, woods, or petroleum gas or fossil fuel, but in the modern time, electricity is easily available and can be used to generate infrared radiation, which may be applied to heat and roast food without causing air pollution due to incomplete combustion of fuel or facing difficult of handling flames that might lead to scorching of food. And thus, roasting in this way is made flexible and versatile.

Most of the roasting equipments that are currently available are constructed to provide only one of roasting operation. This problem is also found in movable roasting system that is set up on a cart. No roasting equipment currently available provides both roasting modes of open top grating roasting and top-fired infrared heating roasting. A barbecue lover must purchase two or more types of roasting equipment if he or she wishes to do open top grating roasting, automatic food rotation roasting, and top-fired infrared heating roasting. This certainly doubles or triples the budget that he or she must bear for purchasing the roasting equipment. It is also troublesome that the increased number of equipments also increases the amount of space needed for storing these equipments.

The currently available roasting equipments that provide both open top grating roasting and infrared heating roasting are often constructed in such a way that a heating grate for infrared heat roasting device is arranged beside or next to the flame roasting grate of the traditional open top roasting oven. This is arrangement causes certain problems for the grease dropping and char debris generated by the open top roasting may be unexpectedly transferred to and thus staining the heating grate of the infrared heating roasting device when the flame roasted food stuffs are being moved. This deteriorates the performance of the infrared heating roasting in suppressing surface scorching of food.

In view of the above discussed drawback of the known roasting equipments that often provide only a single roasting mode and do not allow a user to take options among open top grating roasting, automatic food rotation roasting and infrared heating roasting, the present invention aims to provide a multi-function roaster system that overcomes such a problem.

### SUMMARY OF THE INVENTION

Thus, the present invention provides a multi-function roaster system, which comprises a roasting oven serving as a main body defining a chamber delimited by two oven sidewalls to which a liftable cover is rotatably connected. An open top grating roasting assembly is arranged at a bottom of the roasting oven. At a suitable location adjacent to an inner top of the liftable cover, an infrared heating roasting assembly is frame-supported on the oven back wall. Arranged at a bottom of the infrared heating roasting assembly is a reflection plate that is inclined downward in a rearward direction to guide grease dropping induced by infrared heating roasting away from an open top roasting site on a lower portion and to reflect infrared radiation to a bottom of a heating grating for heating food, whereby a single roaster system may be selectively operated in multiple roasting modes including open top grating roasting and top fired infrared heating roasting and thus allow a user to perform various skills of roasting. This is an objective of the present invention.

Further, in the multi-function roaster system according to the present invention, since the heating grating of the infrared heating roasting is set high away from an open top roasting site on the lower side, the food stuff that is roasted with infrared heating is located at an altitude substantially leveling to the chest of a roast operator so as to allow for easy visual inspection of color change of food being cooked. Further, besides the traditional open top grating roasting that applies heat to the bottom of food stuff, the present invention provides an option for smoke-free roasting with infrared heating. The heat for roasting in the infrared heating roasting is supplied from an upward inclined location to heat the top of the food stuff positioned on a heating grating, so that the top of the food stuff can be faster roasted than the bottom of the food stuff and visual inspection of the top of food stuff is easier than that of the bottom of the food stuff. Consequently, a roast operator may easy identify if food stuff is going to be over-cooked and is getting scorched so that scorching of food can be prevented. This is another objective of the present invention.

Further, the multi-function roaster system according to the present invention allows for easy switching between open top grating roasting and top fired infrared heating roasting, so that a single roaster system can carry out various modes of roasting, including roasting of whole duck/chicken, and the facility installation cost can be reduced. Further, the roasting oven provides a chamber inside which top fired infrared heating roasting and open top grating roasting are spaced from each other in a vertical direction, so that, in moving flame roasted foods, the grease dropping and char debris generated by the flame roasting will not be unexpectedly transferred in an upward direction to contaminate the heating grating of the top fired infrared heating roasting device. Further, food can be first roasted with open top grating roasting and then transferred to the heating grating on the upper side for carrying out elaborate infrared heating roasting, so as to ensure the advantage of reduced surface scorching of food provided by the infrared heating roasting. The vertical arrangement also helps reducing the amount of space occupied by the system. This is a further objective of the present invention.

Further, the multi-function roaster system according to the present invention comprises a reflection plate that is downward inclined in a rearward direction and is placed at the bottom of the top fired infrared heating roasting assembly, whereby the grease dropping from infrared heating roasting of food is kept away from an open top roasting site of the open top grating roasting assembly on the lower side and is guided to a grease tray on the bottom of the roasting oven to be collected together with the grease induced from food by flame roasting and char debris without causing staining of the open top grating roasting assembly. This is yet a further objective of the present invention.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a roasting oven constituting in part a multi-function roaster system according to the present invention.

FIG. 2 is an exploded view of the roasting oven of the multi-function roaster system according to the present invention.

FIG. 3 is a perspective view of the roasting oven of the multi-function roaster system according to the present invention of which certain parts are removed to expose a motor-based drive assembly thereof.

FIG. 4 illustrates power transmission for performance of automatic rotation of food stuff in the multi-function roaster system according to the present invention.

FIG. 5 illustrates automatic food rotation roasting with the multi-function roaster system according to the present invention.

FIG. 6 illustrates infrared heating roasting operation of food with the multi-function roaster system according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

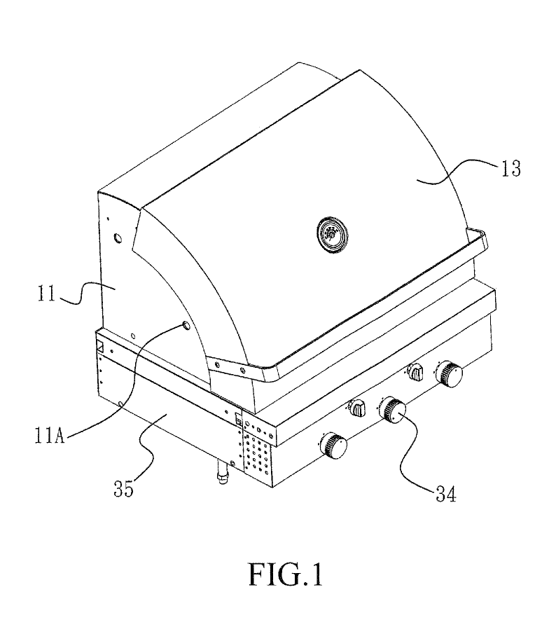

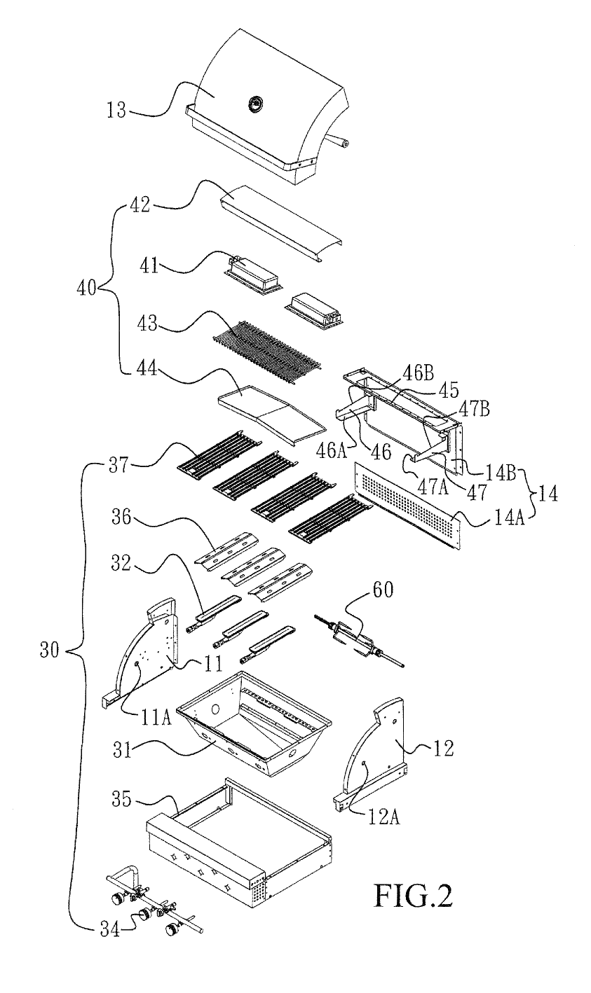

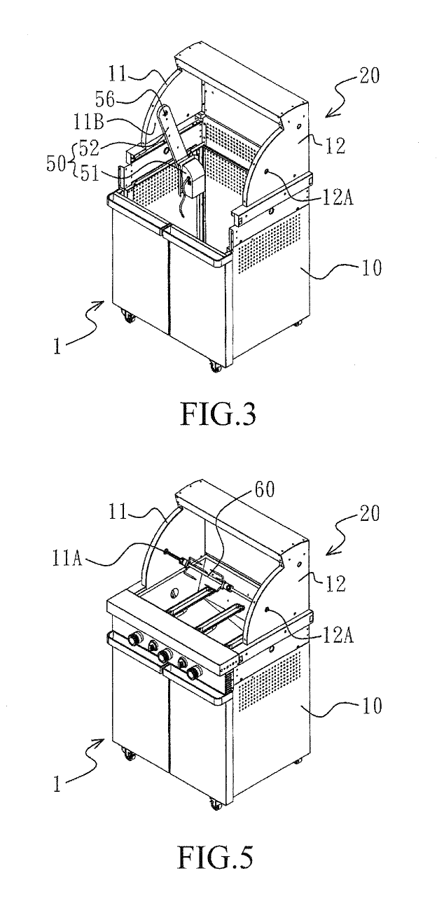

FIG. 1 shows a perspective view of a roasting oven constituting in part a multi-function roaster system according to the present invention, FIG. 2 shows an exploded view of the roasting oven of the multi-function roaster system according to the present invention, and FIG. 3 shows a perspective view of the roasting oven of the multi-function roaster system according to the present invention of which certain parts are removed to expose a motor-based drive assembly thereof. As shown in the drawings, the present invention provides a roaster system 1 comprising a roasting oven 20, which, serving a main body of the roaster system 1, comprises a chamber delimited by two oven sidewalls 11, 12 to which a liftable cover 13 is rotatably connected. A cart chassis 10 is selectively and additionally mounted below the roasting oven 20 to form a roaster cart. Arranged at the bottom of the roasting oven 20 is a near-flame grating roasting assembly 30, which is composed of a grease tray 31, at least one burner 32, a controller frame 35 to which ignition switches 34 are mounted, a perforated shielding plate 36 shielding each burner 32, and roasting gratings 37 that are set on an opening of the grease tray 31. The grease tray 31 may serve as a lowermost bottom wall of the roasting oven 20 and is surrounded and supported by the controller frame 35. The burners 32 are set in the grease tray 31 at a suitable location above a surface of grease with a flammable gas entrance of each burner 32 extending out of the grease tray 31 for connection with an external flammable gas supply source (not shown in the drawings) and the corresponding ignition switches 34. The perforated shielding plates 36 are set between the roasting gratings 37 and the burners 32 to shield and prevent grease dropping of roasted food and char debris from blocking flame openings of the burners 32. The oven sidewalls 11, 12 are erected upward on top edges of the controller frame 35. The roasting oven 20 has an oven back wall 14 that is erected upward on an edge of the controller frame 35 that is opposite to the side of the controller frame 35 where the ignition switches 34 are mounted. The oven back wall 14 is composed of a lower back panel 14A atop which an upper back panel 14B is mounted to form a complete panel.

At a suitable location close to an inner top of the liftable cover 11, a frame 45 projects from a top of the oven back wall 14. Further, at a location below the frame 45, two brackets 46, 47, each of which comprises a bottom support board 46A, 47A extending rearward in a downward inclined manner and has a top forming a horizontal support edge 46B, 47B, are arranged for supporting thereon an infrared heating roasting assembly 40. The infrared heating roasting assembly 40 is composed of a set of infrared generator 41, an infrared burner cover board 42, a heating grating 43, and a reflection plate 44. The reflection plate 44 is positioned on and supported by the bottom support boards 46A, 47A of the brackets 46, 47 and the heating grating 43 is positioned on and supported by the horizontal support edges 46B, 47B of the brackets 46, 47. The infrared generator set 41 is positioned on and supported by the frame 45. The infrared burner cover board 42 is set to cover the infrared generator 41, whereby an emission end of the infrared generator 41 may radiate and heat the space around the heating grating 43.

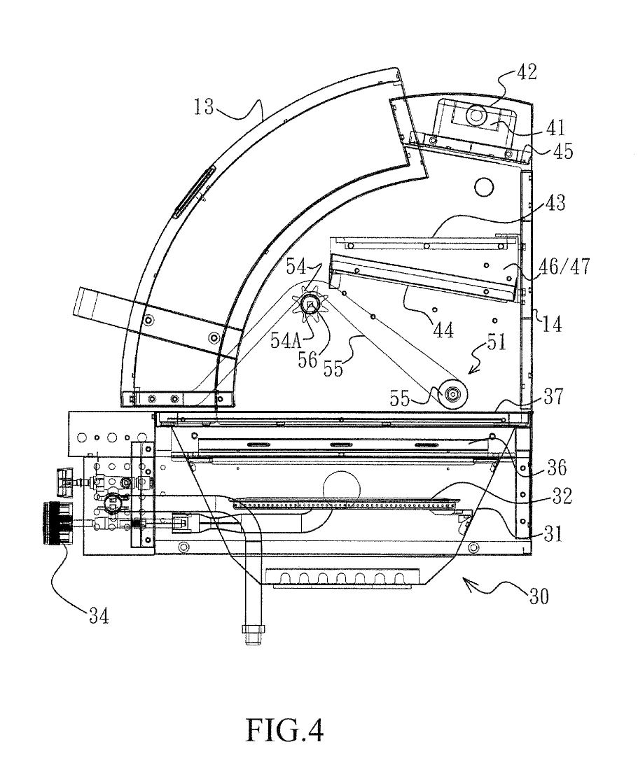

The two oven sidewalls 11, 12 form insertion holes 11A, 12A at opposite locations that are substantially higher than an on-flame roasting site. As shown in FIG. 3, at least one of the oven sidewalls, such as the sidewall 11, is provided with an internal wall board 11B spaced therefrom and accommodating and supporting a motor-based drive assembly 50. The motor-based drive assembly 50 comprises a motor assembly 51 that is coupled to a transmission box 52 as an external configuration thereof, which is arranged to have a terminal transmission shaft hole 56 of the motor-based drive assembly 50 exposed on the transmission box 52 and substantially in alignment with the insertion hole 11A shown in FIG. 2. Internal components of the motor-based drive assembly 50 that are received in the transmission box 52 can be observed in FIG. 4, which illustrates power transmission for performance of automatic rotation of food stuff in the roaster system. Inside the transmission box 52, the motor-based drive assembly 50 comprises a chain 53 mating a driven gear 54 and also mating an on-motor driving gear 55 mounted to the motor assembly 51. Further, the driven gear 54 has a central bore 54A that serves as the terminal transmission shaft hole 56 that is in alignment with the insertion hole 11A shown in FIG. 2.

As shown in FIG. 5, for automatic food rotation roasting operation, an optional rotation roasting fork 60 is provided and received in the insertion holes 11A, 12A, and an end of the rotation roasting fork 60 further extends into the terminal transmission shaft hole 56 shown in the previous drawings. Food to be roasted can be mounted to the rotation roasting fork 60 by being pierced through by the fork and then the motor assembly 51 is turned on and the burners 32 are set in fire to proceed with rotation roasting of the food stuff.

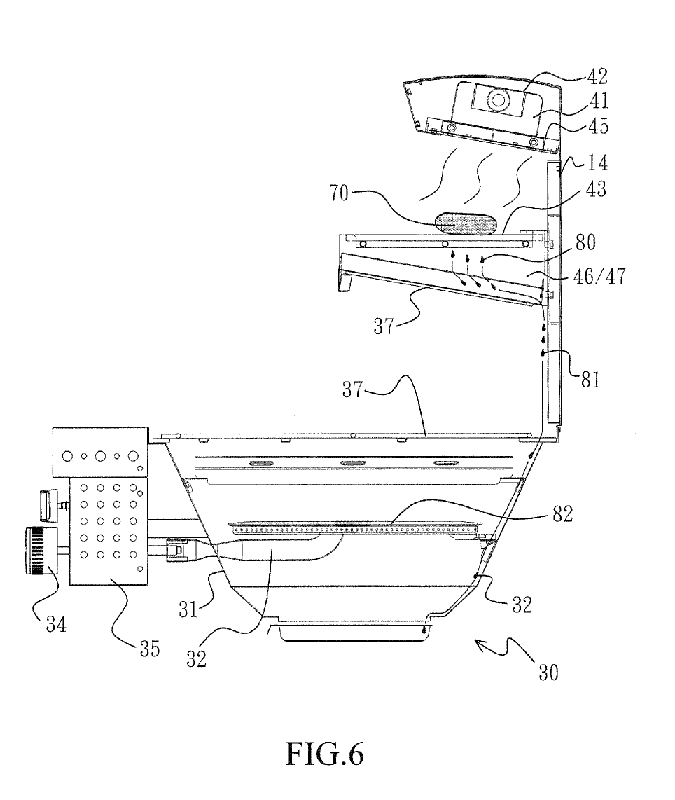

Further, as shown in FIG. 6, for infrared heating roasting operation of food, except near-flame roasting of food stuff positioned on the roasting gratings 37, the present invention is applicable to heat and roast food stuff with infrared radiation by positioning food stuff 70 on the heating grating 43 and turning on the infrared generator 41 of the infrared heat roasting assembly 40 to emit infrared radiation for heating and roasting the food stuff 70 positioned on the heating grating 43. Further, the reflection plate 44 that is arranged at the bottom of the top fired infrared heating roasting assembly 40 is set inclined downward in a rearward direction to reflect the infrared radiation from the infrared generator 41, making the infrared radiation travelling backward through the heating grating 43 for heating the bottom side of the food stuff 70, so that infrared heating roasting can be made uniform. Grease droppings 80, 81, 82 caused by infrared heating of food is allowed to drop onto the reflection plate 44 and moving along the inclination of the reflection plate 44 to a location far rearward away from the on-flame roasting site of the near-flame grating roasting assembly 30 for further dropping down to the grease tray 31 on the bottom of the roasting oven 20 and collected there together with the grease induced by flame roasting and char debris without staining the open top grating roasting assembly 30.

To conclude, the multi-function roaster system according to the present invention provides three modes of roasting, including open top grating roasting, automatic food rotation roasting, and top fired infrared heating roasting.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A multi-function roaster system, comprising a roasting oven that defines a chamber delimited by two oven sidewalls to which a liftable cover is rotatably mounted, a open top grating roasting assembly being arranged at a bottom of the roasting oven, characterized in that at a suitable location adjacent to an inner top of the liftable cover, an infrared heating roasting assembly is frame-supported on an oven back wall, the infrared heating roasting assembly comprising a reflection plate that is inclined downward in a rearward direction and is arranged at a bottom of the top fired infrared heating roasting assembly to guide greasing dropping induced by infrared heating roasting away from an open top roasting site on a lower portion to reach a grease tray set on a bottom of the roasting oven to be collected therein and to reflect infrared radiation to heat a bottom side of a heating grating, whereby multiple modes of roasting are selectively realized, wherein the open top grating roasting assembly comprises the grease tray, at least one burner, a controller frame to which an ignition switch is mounted, a perforated shielding plate that shields the burner, and a roasting grating mounted on an opening of the grease tray, the grease tray sewing as a bottom of the roasting oven and being surrounded and held by the controller frame, the burner being set in the grease tray at a location above a surface of grease with a flammable gas entrance of the burner extending out of the grease tray to be adapted to connect to an external flammable gas supply source and the ignition switch, the perforated shielding plate being set between the roasting grating and the burner to shield and prevent grease dropping from roasted food and char debris from blocking a flame opening of the burner, the oven sidewalls being erected upward on top edges of the controller frame, the roasting oven having an oven back wall that is erected upward on an edge of the controller frame that is opposite to the ignition switch.

2. The multi-function roaster system according to claim 1, wherein the oven back wall comprises a lower back panel atop which an upper back panel is mounted.

3. The multi-function roaster system according to claim 1, wherein at the suitable location adjacent the inner top of the liftable cover, a frame projects from a top of an oven back wall and at a location below the frame, two brackets, each of which comprises a bottom support board extending rearward in a downward inclined manner and has a top forming a horizontal support edge, are arranged, whereby the infrared heating roasting assembly is mounted on the oven back wall.

4. The multi-function roaster system according to claim 3, wherein the infrared heating roasting assembly comprises an infrared generator, an infrared burner cover board, the heating grating, and the reflection plate, the reflection plate being positioned on and supported by the bottom support boards of the brackets, the heating grating being positioned on and supported by the horizontal support edges of the brackets, the infrared generator being positioned on and supported by the frame, the infrared burner cover board being set to cover the infrared generator, whereby an emission end of the infrared generator is allowed to radiate and heat a space around the heating grating.

5. The multi-function roaster system according to claim 1, wherein the two oven sidewalls form insertion holes at opposite locations that are substantially higher than an on-flame roasting site, at least one of the oven sidewalls being provided with an internal wall board spaced therefrom and accommodating and supporting a motor-based drive assembly, the motor-based drive assembly having a terminal transmission shaft hole substantially in alignment with the insertion holes to allow a rotation roasting fork to be received in the insertion holes and to further extend into the terminal transmission shaft hole for holding and carrying food stuff thereon for roasting.

6. The multi-function roaster system according to claim 5, wherein the motor-based drive assembly comprises, in an external configuration, a motor assembly coupled to a transmission box, the terminal transmission shaft hole of the motor-based drive assembly being exposed on the transmission box to align to the insertion holes, the transmission box receiving therein a chain mating a driven gear and an on-motor driving gear mounted to the motor assembly, the driven gear having a central bore serving as the terminal transmission shaft hole that is in alignment with the insertion holes.
